(19) United States
(12) Patent Application Publication
(10) Pub. No.: US 2006/0250257 A1
(43) Pub. Date: Nov. 9, 2006

(54) Sensor orientation for environmental error reduction

(76) Inventor: Christopher I. Reynolds, Walpole, MA (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/124,725

(22) Filed: May 9, 2005

(51) Int. Cl. G01W 1/00

(52) U.S. Cl. 340/601

(57) ABSTRACT

A processor of an apparatus in one example makes a determination of an environmental characteristic based on a plurality of concomitant values that correspond to the environmental characteristic. A plurality of sensors obtains the plurality of concomitant values. The plurality of sensors configured in a plurality of orientations.

### TECHNICAL FIELD

The invention relates generally to signal processing and more particularly to error reduction in gyroscopes.

### BACKGROUND

Electronic sensors are often used for measurement of environmental characteristics. Gyroscopes are capable of measuring inertial characteristics, such as angular rate and/or acceleration. Outputs from gyroscopes may be unstable due to error terms that vary over time. Some error terms are caused by environmental changes to the gyroscope, such as temperature fluctuation, shock, and vibration. The error terms may or may not be correlated with each other and may or may not vary between gyroscopes. A specialized and more precise gyroscope may be used to reduce the error terms, but at a higher manufacturing cost.

Thus, a need exists for reduced error terms resulting from environmental effects that otherwise would degrade measurement accuracy without higher manufacturing costs.

### SUMMARY

The invention in one implementation encompasses an apparatus. The apparatus comprises a plurality of sensors that obtain a plurality of concomitant values indicative of an environmental characteristic, the plurality of sensors being configured respectively in a plurality of orientations; and a processor having a plurality of inputs for receiving the plurality of concomitant values and having an output that provides a determination of the environmental characteristic.

Another implementation of the invention encompasses an apparatus. The apparatus comprises a plurality of sensors that obtain a plurality of concomitant values indicative of an environmental characteristic, the plurality of sensors being configured respectively in a plurality of orientations; and a processor having a plurality of inputs for receiving the plurality of concomitant values and having an output that provides a determination of the environmental characteristic; each sensor of the plurality of sensors associated with a three-dimensional unit vector, axes of the plurality of sensors lying along a common three-dimensional unit vector; the plurality of sensors being configured in at least one opposing orientation set; each opposing orientation set comprising first and second sensors; the second sensor having an orientation that is rotated about the three-dimensional unit vector by 180 degrees and/or inverted on the three-dimensional unit vector relative to an orientation of the first sensor.

Another implementation of the invention encompasses a method. The method comprises obtaining, via a plurality of sensors, a plurality of concomitant values indicative of an environmental characteristic, the plurality of sensors being configured respectively in a plurality of orientations, each sensor of the plurality of sensors associated with a three-dimensional unit vector, axes of the plurality of sensors lying along a common three-dimensional unit vector, the plurality of sensors being configured in at least one opposing orientation set, with each opposing orientation set comprising first and second sensors, the second sensor having an orientation that is rotated about the three-dimensional unit vector by 180 degrees and/or inverted on the three-dimensional unit vector relative to an orientation of the first sensor; and calculating from the plurality of concomitant values at least a single value indicative of the environmental characteristic.

### DESCRIPTION OF THE DRAWINGS

Features of exemplary implementations of the invention will become apparent from the description, the claims, and the accompanying drawings in which:

FIG. 1 is a representation of one implementation of an apparatus that comprises a circuit with a processor and a plurality of sensors in a plurality of orientations.

FIG. 2 is a representation of one implementation of the circuit of FIG. 1 where the plurality of sensors are configured in a plurality of opposing orientation sets.

FIG. 3 is a representation of one implementation of the circuit of FIG. 1 where the plurality of sensors is configured in a plurality of opposing orientation sets.

FIG. 4 is an exemplary table of output error for three individual gyroscopes.

FIG. 5 is an exemplary plot of output for sixteen gyroscopes in a configuration of the apparatus of FIG. 3.

### DETAILED DESCRIPTION

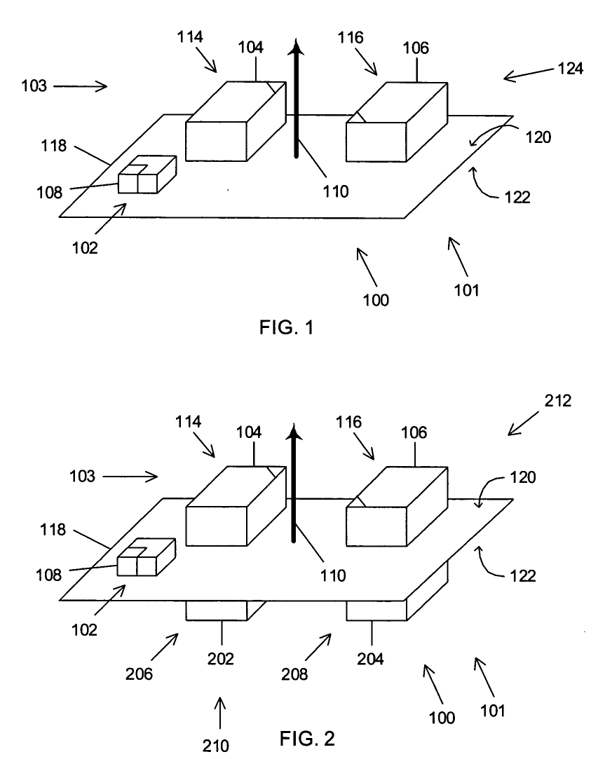

Turning to FIG. 1, an apparatus 100 in one example comprises an electrical and/or optical circuit 101, for example, a circuit board 118. The circuit 101 in one example comprises a processor 102 and a plurality of n sensors 103, for example, sensors 104 and 106. The circuit board 118 in one example comprises a first face 120 and a second face 122. The processor 102 and the plurality of sensors 103 are coupled with the first face 120 and/or the second face 122. The processor 102 and the plurality of sensors 103 are electrically and/or optically coupled with each other, for example, by electrical traces. The processor 102 in one example comprises a signal processor. For example, the processor 102 receives signals from the plurality of sensors 103. The processor 102 in one example comprises a digital signal processor. In another example, the processor 102 comprises an analog signal processor. In yet another example, the processor 102 comprises an analog/digital converter for conversion of signals between an analog format and a digital format. The processor 102 makes a determination of an environmental characteristic based on an average of a plurality of concomitant values that correspond to the environmental characteristic. The processor 102 in one example comprises an instance of a recordable data storage medium 108, as described herein.

The plurality of sensors 103 in one example comprises electronic sensors. In another example, the plurality of sensors 103 comprises optical sensors. The plurality of sensors 103 serves to obtain a plurality of concomitant values that correspond to the environmental characteristic for the processor 102. For example, the plurality of sensors 103 measures the environmental characteristic. The environmental characteristic in one example comprises an inertial characteristic, for example, an angular rate or angular acceleration. The plurality of sensors 103 in one example comprise one or more gyroscopes for measuring the angular rate and/or one or more accelerometers for measuring the angular acceleration. In a further example, the plurality of sensors 103 comprise Micro-Electro-Mechanical Systems (MEMS) gyroscopes and/or accelerometers. The gyroscopes and/or accelerometer may be single- and/or multi-axis, as will be appreciated by those skilled in the art.

The plurality of sensors 103 in one example comprises independent sensors. For example, each of the plurality of sensors 103 provides a value that corresponds to a measurement of the environmental characteristic. The plurality of sensors 103 in one example provides the pre-determined clock signal. In another example, the plurality of sensors 103 operates in real-time. For example, the plurality of sensors 103 provides a continuous output of the value. The plurality of sensors 103 in one example provide the values substantially in parallel, as will be appreciated by those skilled in the art.

The plurality of sensors 103 is configured in a plurality of orientations. For example, the sensors 104 and 106 are configured in different orientations. Each sensor of the plurality of sensors 103 is oriented with respect to a same three-dimensional unit vector 110. For example, the sensors 104 and 106 are oriented along the three-dimensional unit vector 110. In one example where the sensors 104 and 106 comprise gyroscopes, the gyroscopes provide angular rate measurements about the three-dimensional unit vector 110 with either a positive or negative magnitude, as described herein.

The value that corresponds to the measurement of the environmental characteristic from each sensor of the plurality of sensors 103 comprises one or more error terms. One cause for error terms is shock and/or vibration to the plurality of sensors 103. The error terms due to shock and/or vibration in one example are related to orders of g, g², g³, and higher orders of g. The effect of the error terms on the measurement of the environmental effect in one example are reduced by combining the values from the plurality of sensors 103, where the plurality of sensors 103 are configured in different orientations, as will be appreciated by those skilled in the art.

Referring to FIG. 1, the plurality of orientations in one example comprises a first orientation 114 and a second orientation 116. The second orientation 116 is rotated about the three-dimensional unit vector 110 relative to the first orientation 114. The second orientation 116 in one example is rotated by 180 degrees about the three-dimensional unit vector 110 relative to the first orientation 114. Other exemplary values for rotation about the three-dimensional unit vector 110 comprise 0, 45, 90, 135, 225, 270, and 315 degrees.

Turning to FIG. 2, the plurality of sensors 103 in one example further comprise third sensor 202 and fourth sensor 204. The plurality of orientations in one example comprises a third orientation 206 and a fourth orientation 208. The third sensor 202 in the third orientation 206 is inverted on the three-dimensional unit vector 110 relative to the first orientation 114. In one example, the circuit 101 comprises a circuit board 118. The sensor 104 is coupled to the top face 120 of the circuit board 118 in the first orientation 114. The sensor 202 is coupled to the bottom face 122 of the circuit board 118 in the third orientation 206. The fourth sensor 204 in the fourth orientation 208 in one example is inverted on the three-dimensional unit vector 110 and rotated by 180 degrees about the three-dimensional unit vector 110 relative to the first orientation 114.

The processor 102 reduces error terms that are related to g and g³ by combining the values from sensors in the first orientation 114 and the second orientation 116. The processor 102 reduces error terms that are related to g² by combining the values from sensors in the first orientation 114 and the third orientation 206. The processor 102 reduces error terms that are related to g, g², and g³ by combining the values from sensors in the first orientation 114 and the fourth orientation 208, as will be appreciated by those skilled in the art.

Referring to FIGS. 1 and 2, the plurality of sensors 103 in one example are configured in one or more opposing orientation sets 124, 210, and/or 212. The opposing orientation set 124 in one example comprises sensors 104 and 106 configured in the first orientation 114 and the second orientation 116, respectively. The opposing orientation set 210 in one example comprise sensors 104 and 202 configured in the first orientation 114 and the third orientation 206, respectively. In another example, the opposing orientation set 212 comprises the first sensor 104, the second sensor 106, the third sensor 202, and the fourth sensor 204 in the first orientation 114, the second orientation 116, the third orientation 206, and the fourth orientation 208, respectively.

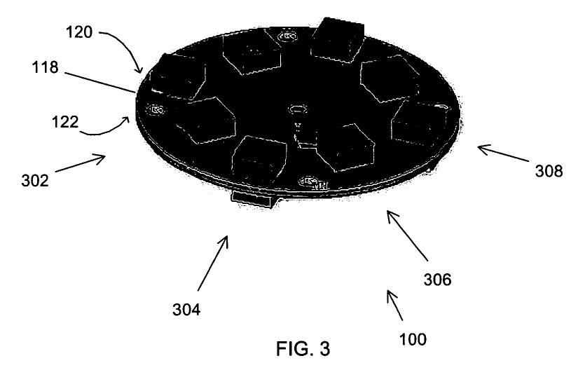

Turning to FIG. 3, the plurality of sensors 103 in one example are configured in a plurality of opposing orientation sets, for example, opposing orientation sets 302, 304, 306, and 308. Each opposing orientation set of the plurality of opposing orientation sets 302, 304, 306, and 308 comprises a plurality of sensors, for example, the first sensor 104, the second sensor 106, the third sensor 202, and the fourth sensor 204 in the first orientation 114, the second orientation 116, the third orientation 206, and the fourth orientation 208, respectively, for a total of sixteen sensors. The plurality of opposing orientation sets 302, 304, 306, and 308 in one example are oriented along the three-dimensional unit vector 110. The opposing orientation sets 304, 306, and 308 in one example are rotated about the three-dimensional unit vector 110, relative to the opposing orientation set 302, by 45, 90, and 135 degrees, respectively.

An illustrative description of exemplary operation of the apparatus 100 is presented, for explanatory purposes. Referring to FIG. 3, each sensor of the plurality of sensors 103 determines a value that corresponds to a measurement of the environmental characteristic. For example, the plurality of sensors 103 determines a plurality of independent values. The processor 102 obtains the plurality of independent values from the plurality of sensors 103. The values for the environmental characteristic comprise error terms, for example, a drift scaling factor, noise, and drift rate. One or more error terms is caused by shock and/or vibration experienced by one or more of the plurality of sensors 103. The processor 102 makes a determination of the environmental characteristic based on the plurality of values to reduce an effect of the error terms.

Where the plurality of sensors 103 comprise gyroscopes, the sensors 104, 106, 202, and 204 provide first, second, third, and fourth angular rate measurements that correspond to an angular rate. Each of the first, second, third, and fourth angular rate measurements comprises a magnitude that is substantially similar. However, a sign of the first and second angular rate measurements will be opposite a sign of the third and fourth angular rate measurements, as will be understood by those skilled in the art.

The processor 102 determines a difference between the first angular rate measurement and the third angular rate measurement to obtain a first result value. The error terms due to vibration and/or shock of the first angular rate measurement and the third angular rate measurement are partially and/or completely cancel each other out and the first result value has approximately two times the magnitude of the first or third angular rate measurement. The first result value also has a reduced error term, as will be appreciated by those skilled in the art.

The processor 102 in one example combines the first result value with a second result value. The processor 102 obtains the second result value from the second and fourth angular rate measurements in the same manner as the first result value. The processor 102 obtains the first and second result values such that they are of the same sign. The processor 102 performs an average of the first and second result values to obtain a determination of the environmental effect. Where the plurality of sensors 103 are configured in the plurality of opposing orientation sets 302, 304, 306, and 308, the processor 102 performs an average of the result values from each opposing orientation set, as will be appreciated by those skilled in the art.

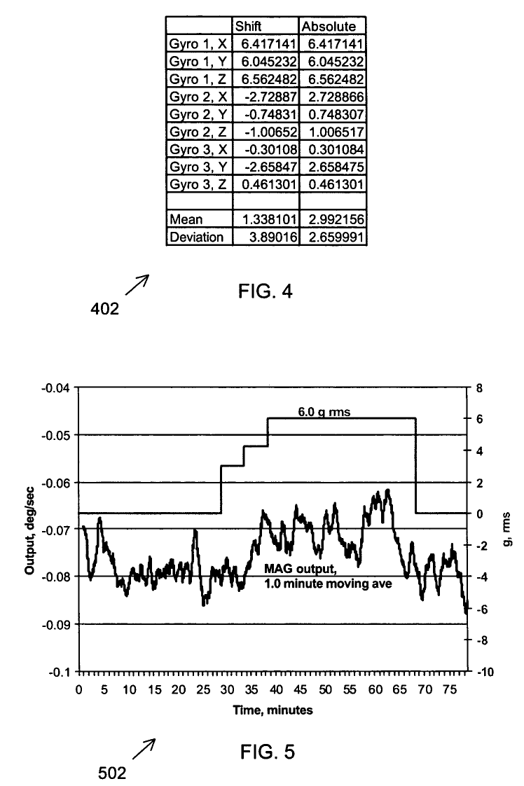

Turning to FIGS. 4, table 402 comprises an exemplary table of output error for three individual gyroscopes. The output error comprises an output g² error while the gyroscopes were exposed to up to 18 g of random vibration. The absolute mean of the output error is approximately 2.99 degrees per hour per g². Turning to FIG. 5, plot 502 comprises an exemplary plot of output for sixteen gyroscopes in the configuration of FIG. 3 exposed to up to 6 g of random vibration. The output from the sixteen gyroscopes of plot 502 changes approximately 0.8 degrees per second. The output error is approximately 0.8 degrees per hour per g².

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. The computer-readable signal-bearing media store software, firmware and/or assembly language for performing one or more portions of one or more embodiments of the invention. Examples of a computer-readable signal-bearing medium for the apparatus 100 comprise the recordable data storage medium 114 of the processor 102. The computer-readable signal-bearing medium for the apparatus 100 in one example comprise one or more of a magnetic, electrical, optical, biological, and atomic data storage medium. For example, the computer-readable signal-bearing medium comprises floppy disks, magnetic tapes, CD-ROMs, DVD-ROMs, hard disk drives, and electronic memory. In another example, the computer-readable signal-bearing medium comprises a modulated carrier signal transmitted over a network comprising or coupled with the apparatus 100, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a plurality of sensors that obtain a plurality of concomitant values indicative of an environmental characteristic, the plurality of sensors being configured respectively in a plurality of orientations; and
a processor having a plurality of inputs for receiving the plurality of concomitant values and having an output that provides a determination of the environmental characteristic;.

2. The apparatus of claim 1, wherein each sensor of the plurality of sensors lies along a common three-dimensional unit vector;
wherein the plurality of orientations comprise a first orientation and a second orientation; and
wherein the second orientation is inverted on the three-dimensional unit vector relative to the first orientation.

3. The apparatus of claim 2, wherein the plurality of sensors comprise electronic sensors; and
wherein at least one of the plurality of electronic sensors is coupled to a first side of a circuit board and at least one of the plurality of electronic sensors is coupled to a second side of the circuit board.

4. The apparatus of claim 2, wherein the environmental characteristic comprises an angular rate;
wherein the plurality of sensors comprise a first gyroscope that obtains a first value of the plurality of concomitant values and a second gyroscope that obtains a second value of the plurality of concomitant values; and
wherein the processor determines a difference between the first value and the second value such that an error term of the angular rate that corresponds to a second order gravity term is reduced.

5. The apparatus of claim 1, wherein each sensor of the plurality of sensors is associated with a three-dimensional unit vector;
wherein axes of the plurality of sensors lie along a common three-dimensional unit vector;
wherein the plurality of orientations comprise a first orientation and a second orientation; and
wherein the second orientation is rotated about the three-dimensional unit vector relative to the first orientation.

6. The apparatus of claim 5, wherein the second orientation is rotated about the three-dimensional unit vector by one of 0, 45, 90, 135, 180, 225, 270, or 315 degrees relative to the first orientation.

7. The apparatus of claim 5, wherein the environmental characteristic comprises an angular rate;
wherein the plurality of sensors comprise a first gyroscope that obtains a first value of the plurality of concomitant values and a second gyroscope that obtains a second value of the plurality of concomitant values;
wherein the first gyroscope has the first orientation;
wherein the second gyroscope has the second orientation;
wherein the second orientation is rotated about the three-dimensional unit vector by 180 degrees relative to the first orientation; and
wherein the processor determines a difference between the first value and the second value such that error terms of the angular rate that corresponds to a first order gravity term and/or third order gravity term is reduced.

8. The apparatus of claim 1, wherein the plurality of sensors comprise at least one of gyroscopes and accelerometers; and
wherein the environmental characteristic comprises at least one of an angular rate and an angular acceleration.

9. An apparatus, comprising:
a plurality of sensors that obtain a plurality of concomitant values indicative of an environmental characteristic, the plurality of sensors being configured respectively in a plurality of orientations; and
a processor having a plurality of inputs for receiving the plurality of concomitant values and having an output that provides a determination of the environmental characteristic
each sensor of the plurality of sensors associated with a three-dimensional unit vector, axes of the plurality of sensors lying along a common three-dimensional unit vector;
the plurality of sensors being configured in at least one opposing orientation set;
each opposing orientation set comprising first and second sensors; and
the second sensor having an orientation that is rotated about the three-dimensional unit vector by 180 degrees and/or inverted on the three-dimensional unit vector relative to an orientation of the first sensor.

10. The apparatus of claim 9, wherein each opposing orientation set of the at least one opposing orientation set comprises the first sensor, the second sensor, a third sensor, and a fourth sensor;
wherein the second sensor has an orientation that is rotated about the three-dimensional unit vector by 180 degrees relative to the orientation of the first sensor;
wherein the third sensor has an orientation that is inverted on the three-dimensional unit vector relative to the orientation of the first sensor; and
wherein the fourth sensor has an orientation that is inverted on the three-dimensional unit vector relative to the orientation of the first sensor and rotated about the three-dimensional unit vector by 180 degrees relative to the orientation of the first sensor.

11. The apparatus of claim 10, wherein the at least one opposing orientation set comprises first, second, third, and fourth opposing orientation sets;
wherein the first sensor of the second opposing orientation set has an orientation that is rotated about the three-dimensional unit vector by 45 degrees relative to the first sensor of the first opposing orientation set;
wherein the first sensor of the third opposing orientation set has an orientation that is rotated about the three-dimensional unit vector by 90 degrees relative to the first sensor of the first opposing orientation set; and
wherein the first sensor of the fourth opposing orientation set has an orientation that is rotated about the three-dimensional unit vector by 135 degrees relative to the first sensor of the first opposing orientation set.

12. The apparatus of claim 9, wherein the at least one opposing orientation set comprise a plurality of opposing orientation sets;
wherein each opposing orientation set of the plurality of opposing orientation sets provides a value of the environmental characteristic to the processor; and
wherein the processor determines an average of the values of the environmental characteristic.

13. A method, comprising:
obtaining, via a plurality of sensors, a plurality of concomitant values indicative of an environmental characteristic, the plurality of sensors being configured respectively in a plurality of orientations, each sensor of the plurality of sensors associated with a three-dimensional unit vector, axes of the plurality of sensors lying along a common three-dimensional unit vector, the plurality of sensors being configured in at least one opposing orientation set, with each opposing orientation set comprising first and second sensors, the second sensor having an orientation that is rotated about the three-dimensional unit vector by 180 degrees and/or inverted on the three-dimensional unit vector relative to an orientation of the first sensor; and
calculating from the plurality of concomitant values at least a single value indicative of the environmental characteristic.

14. The method of claim 13, wherein each opposing orientation set of the at least one opposing orientation set comprises the first sensor, the second sensor, a third sensor, and a fourth sensor;
wherein the second sensor has an orientation that is rotated about the three-dimensional unit vector by 180 degrees relative to the orientation of the first sensor;
wherein the third sensor has an orientation that is inverted on the three-dimensional unit vector relative to the orientation of the first sensor; and
wherein the fourth sensor has an orientation that is inverted on the three-dimensional unit vector relative to the orientation of the first sensor and rotated about the three-dimensional unit vector by 180 degrees relative to the orientation of the first sensor.

15. The method of claim 14, wherein the at least one opposing orientation set comprises first, second, third, and fourth opposing orientation sets;
wherein the first sensor of the second opposing orientation set has an orientation that is rotated about the three-dimensional unit vector by 45 degrees relative to the first sensor of the first opposing orientation set;
wherein the first sensor of the third opposing orientation set has an orientation that is rotated about the three-dimensional unit vector by 90 degrees relative to the first sensor of the first opposing orientation set; and
wherein the first sensor of the fourth opposing orientation set has an orientation that is rotated about the three-dimensional unit vector by 135 degrees relative to the first sensor of the first opposing orientation set.

16. The method of claim 13, wherein the at least one opposing orientation set comprise a plurality of opposing orientation sets;
wherein each opposing orientation set of the plurality of opposing orientation sets provides a value of the environmental characteristic to the processor; and
wherein the processor determines an average of the values of the environmental characteristic.
